(19) United States
(12) Patent Application Publication
(10) Pub. No.: US 2014/0348000 A1
(43) Pub. Date: Nov. 27, 2014

(54) NETWORK SYSTEM, METHOD OF CONTROLLING NETWORK SYSTEM, AND NODE DEVICE

(71) Applicant: FUJITSU LIMITED, Kawasaki-shi (JP)

(72) Inventors: Tetsuya IZU, London (GB); Yumi SAKEMI, Kawasaki (JP); Kazuyoshi FURUKAWA, Kawasaki (JP); Hisashi KOJIMA, Yokosuka (JP); Masahiko TAKENAKA, Kawasaki (JP)

(73) Assignee: FUJITSU LIMITED, Kawasaki-shi (JP)

(21) Appl. No.: 14/456,117

(22) Filed: Aug. 11, 2014

Related U.S. Application Data
(63) Continuation of application No. PCT/JP2012/002237, filed on Mar. 30, 2012.

(51) Int. Cl. H04L 12/841; H04L 12/741

(52) U.S. Cl. CPC H04L 47/283; H04L 45/745
USPC 370/236

(57) ABSTRACT

A network system includes: a plurality of node devices including a first node device and a second node device; and a verification node device that has a higher processing capacity than the plurality of node devices. The verification node device transmits a first packet including an identifier indicating the verification node device. The first node device receives a second packet from another node device out of the plurality of node devices, and determines, based on a destination of the second packet, reception of a packet from the second node device, and reception of the first packet, a transmission destination of a third packet that corresponds to reception of the second packet, from among the second node device and the verification node device. And, the verification node device verifies the third packet in a case of receiving the third packet.

### CROSS-REFERENCE TO RELATED APPLICATION

This application is a continuation application of International Application PCT/JP2012/002237 filed on Mar. 30, 2012, the entire contents of which are incorporated herein by reference.

### FIELD

The embodiments discussed herein are related to a technology for transmitting and receiving packets between node devices in an ad hoc network.

### BACKGROUND

The ad hoc network is a type of a self-configuration type network that links using wireless communication. The ad hoc network is configured by a plurality of devices having communication functions. The devices having the communication functions in the ad hoc network are called nodes. In addition, each node within the ad hoc network transmits and receives packets through another node other than a node serving as a communication target, using multi-hop communication, and hence, becomes able to perform communication with the node serving as a communication target without being routed through a relay station such as an access point or a base station. The multi-hop communication is a technique for enabling two nodes not existing in each other's communication areas to perform communication with each other through another node existing in the communication areas of the two nodes.

For example, as a system utilizing the ad hoc network, a meter reading system for collecting power consumption amounts or the like in respective homes through the ad hoc network by incorporating, into electric power meters in the respective homes, nodes capable of performing wireless communication has been known. In this meter reading system, packets including power consumption amounts in the respective homes, detected by the respective electric power meters, are transferred from the nodes included in the electric power meters in the respective homes to a server in an electric power company. In such a system, since pieces of personal information such as usage amounts of electric power and so forth in the respective homes are handled in the ad hoc network, it is desirable to perform secure communication, from a viewpoint of confidentiality, tamper resistance, and so forth.

A technique for securing the confidentiality of information included in packets by encrypting the packets to be transmitted and received between nodes within the ad hoc network has been known.

In addition, a node having received the packets verifies the completeness of data within the packets and the validity of a transmission source of the packets. In addition, the completeness of data within the packets means that no tampered data and no missing data exist in the data set in the packets. In addition, the validity of the transmission source of the packets means that a node officially participating in the ad hoc network is the transmission source.

For example, a technique of the related art has been known where each node detects an improper packet transmitted from an improper node by executing verification of a message authentication code (MAC) for a received packet. In the corresponding technique of the related art, in a case where an improper packet is detected, the corresponding packet is discarded.

As a related art, for example, International Publication Pamphlet No. WO2011/121713 is known.

### SUMMARY

According to an aspect of the invention, a network system includes: a plurality of node devices including a first node device and a second node device; and a verification node device that has a higher processing capacity than the plurality of node devices. The verification node device transmits a first packet including an identifier indicating the verification node device. The first node device receives a second packet from another node device out of the plurality of node devices, and determines, based on a destination of the second packet, reception of a packet from the second node device, and reception of the first packet, a transmission destination of a third packet that corresponds to reception of the second packet, from among the second node device and the verification node device. And, the verification node device verifies the third packet in a case of receiving the third packet.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram for comparing an ad hoc network system according to one of the present embodiments with an ad hoc network system of the related art;

FIG. 2 illustrates an example of a data configuration of a management packet;

FIG. 3 illustrates an example of a data configuration of a data packet;

FIG. 4 is a functional block diagram of a node;

FIG. 5A and FIG. 5B are diagrams for comparing an example of a data configuration of a routing table of the related art with an example of a data configuration of a routing table according to one of the present embodiments;

FIG. 6 is a diagram for explaining a path through which a time packet arrives at a node from a sink node;

FIG. 7 is a diagram for explaining transmission and reception of a hello packet between nodes;

FIG. 8A and FIG. 8B are examples of data stored in a key information storage unit;

FIG. 9 is a functional block diagram of a verification node;

FIG. 10 is a flowchart of routing table generation processing;

FIG. 11 is a flowchart of transfer processing in the node;

FIG. 12 is a flowchart of transfer processing in the verification node;

FIG. 13 is an example of a hardware configuration of the node; and

FIG. 14 is an example of a hardware configuration of the verification node.

### DESCRIPTION OF EMBODIMENTS

In a case where each node performs processing for verifying packets, a load due to the verification processing occurs in each node in addition to transmission and reception processing for the packets. In a case where the processing capacity of each node is not high, in particular it is desirable to minimize a processing load other than the transmission and reception processing.

In a case where a large number of packets are fed from an improper node into a network, a load on verification processing for the entire network increases. In other words, since each node verifies the large number of packets, a decrease in a transfer speed for packets in the network or the like is caused by the processing load due to the verification processing.

Therefore, reducing a processing load due to verification processing in a typical node by causing a device suitable for performing the verification processing to perform the verification processing may be considered. However, in the related art, it is difficult to arbitrarily transfer packets flowing within the network to a device suitable for performing the verification processing and to effectively verify packets flowing through the network.

An object of a technology of the present disclosure is to effectively verify packets flowing within a network.

According to an aspect of the present technology, with respect to packets flowing within a network, it becomes possible to effectively verify the completeness of data within the packets and the validity of a transmission source of the packets.

Hereinafter, embodiments of a communication device, a communication method, and a system according to the present technology will be described in detail with reference to accompanying drawings.

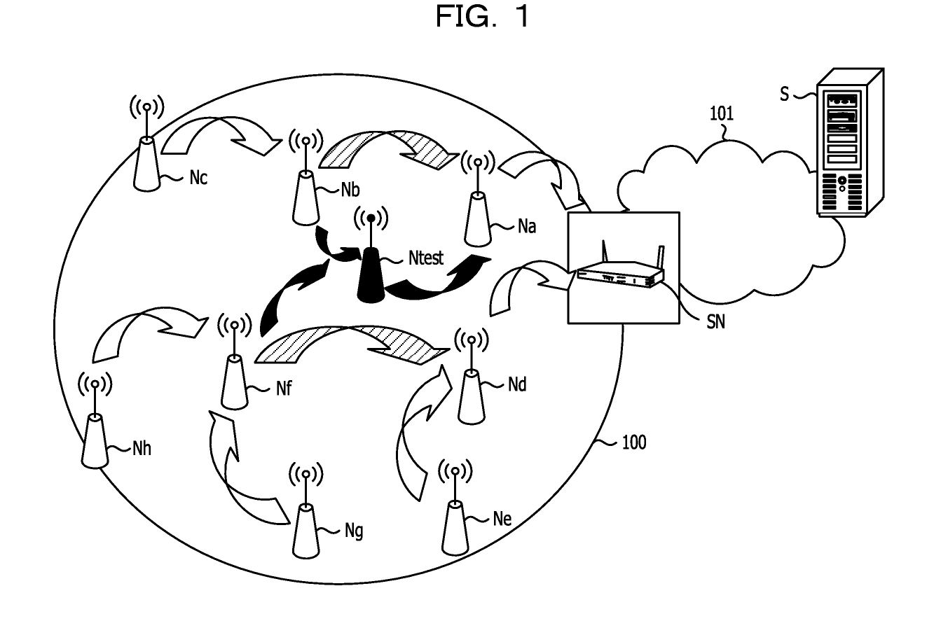

FIG. 1 is an explanatory diagram for comparing an ad hoc network system according to one of the present embodiments with an ad hoc network system of the related art.

The ad hoc network system of the related art includes a plurality of nodes Nx, a sink node SN, and a server S. The server S and the sink node SN are coupled to each other through a typical network 101 such as the Internet, a LAN, or a WAN. The sink node SN and the nodes Nx are coupled to one another through an ad hoc network 100.

Within the ad hoc network 100, the plural nodes Nx are provided. In FIG. 1, as representatives of the plural nodes, nodes Na to Nh are illustrated. In a case of not intending to separate the nodes Na to Nh from one another, the nodes Na to Nh are expressed as nodes Nx in the present specification.

The sink node SN is a relay device that couples the ad hoc network 100 and the typical network 101 to each other. The sink node SN is able to transmit and receive both the information of the format of the protocol of the ad hoc network 100 and the information of the format of the protocol of the typical network 101.

In addition, the sink node SN performs protocol conversion on information and performs communication, between the ad hoc network 100 and the typical network 101. For example, packets transmitted from one of the nodes Nx within the ad hoc network 100 and addressed to the server S are subjected to protocol conversion in the sink node SN. After that, the sink node SN transmits the packets to the typical network 101, and hence, the packets arrive at the server S.

Each node Nx is a device capable of performing multi-hop communication with another node Nx or the sink node SN. Each node Nx performs communication with another node Nx or the sink node SN, which exists within a communication area. In the ad hoc network 100, all the nodes Na to Nh do not have to perform direct communication with the sink node SN, and are able to perform communication with the sink node SN through another node.

Each node Nx generates a routing table. In addition, each node Nx transmits packets in accordance with the routing table. In FIG. 1, in the ad hoc system of the related art, the packets are transmitted to the sink node SN in accordance with paths indicated by outline arrows and shaded arrows.

For example, in a case where packets are transmitted from the node Nc to the sink node SN, the packets from the node Nc are routed through the node Nb and the node Na. In addition, in a process in which the packets are transmitted from the node Nc to the sink node SN, the node Nb and the node Na included in the path each verify the completeness of data within the packets and the validity of a transmission source of the packets with respect to the received packets. For example, the node Nb and the node Na each execute verification using a MAC value.

On the other hand, the ad hoc network system according to one of the present embodiments includes the plural nodes Nx, the sink node SN, and the server S, and further includes a verification node Ntest.

The verification node Ntest is a device whose processing capacity is higher than the nodes Nx. In addition, the verification node Ntest is a device capable of performing multi-hop communication with the nodes Nx. In addition, in the present embodiment, the nodes Nx are each capable of performing multi-hop communication with the verification node Ntest in addition to another node Nx or the sink node SN. In addition, as for the individual nodes Nx, the sink node SN, and the verification node Ntest, another node out thereof exists within a communication area.

In this regard, however, one of the nodes Na to Nh may serve the function of the verification node Ntest. In that case, it is desirable to have a higher processing capacity than the other nodes.

In the present embodiment, the packets are transferred in accordance with a routing table according to one of the present embodiments. In FIG. 1, in the ad hoc system of one of the present embodiments, the packets are transmitted to the sink node SN in accordance with paths indicated by the outline arrows and black arrows.

For example, in a case where packets are transmitted from the node Nc to the sink node SN, the packets from the node Nc are routed through the node Nb, the verification node Ntest, and the node Na. In addition, in a process in which the packets are transmitted from the node Nc to the sink node SN, the verification node Ntest included in the path verifies the completeness of data within the packets and the validity of a transmission source of the packets with respect to the received packets. For example, the verification node Ntest executes verification using a MAC value. Hereinafter, this verification is referred to as MAC verification.

In a case where the packet are transmitted from the node Nc to the sink node SN as described above, the node Nb or Na does not have to execute the MAC verification. However, in a case of having processing capacity to spare, the nodes Nb and Na may execute the MAC verification. In what follows, it is assumed that only the verification node Ntest performs the MAC verification and the node Nx does not implement the MAC verification, and description will be performed.

As indicated by the black arrows in FIG. 1, the ad hoc network system of one of the present embodiments is different from the ad hoc network system of the related art in that the transmission path of packets includes a path routed through the verification node Ntest.

Next, packets flowing in the ad hoc network will be described. The packets flowing in the ad hoc network include various types of packet. For example, the various types of packet include a management packet and a data packet. The management packet is a packet used for sharing information available for each node Nx or the verification node Ntest to perform communication with another node Nx or the sink node SN. The management packet is broadcasted from each node Nx or the verification node Ntest. For example, a hello packet used by each node Nx to distribute a session key to a surrounding node Nx and a time packet used by the sink node SN to distribute time information to each node Nx are included in the management packet.

In addition, the data packet is a packet including data intended to be transmitted to a specified destination. The data packet is unicasted.

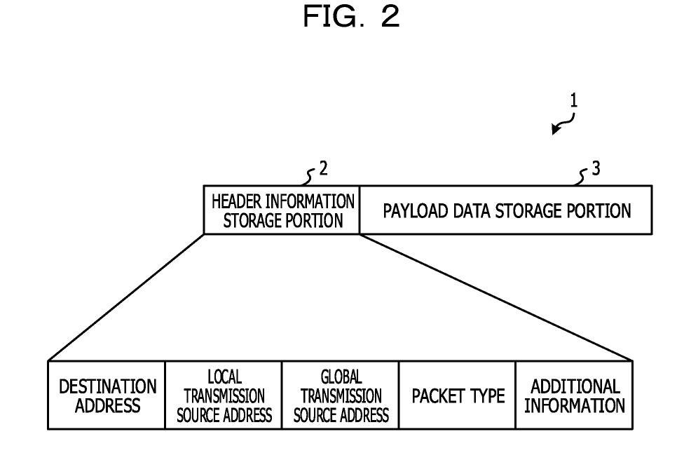

FIG. 2 illustrates an example of the data configuration of the management packet. In addition, the sink node SN, the individual nodes Nx, and the verification node Ntest each broadcast the management packet illustrated in FIG. 2. Accordingly, the management packet is transmitted and received between a broadcasting device and another device existing in an area where the another device is able to communicate with the broadcasting device.

A management packet 1 includes a header information storage portion 2 and a payload data storage portion 3. Header information is stored in the header information storage portion 2. The header information includes a destination address, a local transmission source address, a global transmission source address, a packet type, and additional information. Payload data is stored in the payload data storage portion 3.

The destination address is a particular address dedicated to broadcasting. For example, the destination address is a preliminarily prepared address, “255.255.255.255”. Each node receives packets transmitted so as to be addressed to an individually set address while also receiving packets transmitted so as to be addressed to the corresponding particular address. In other words, packets for which the particular address is set are received by all nodes existing in an area where all nodes are able to communicate with a node that transmits the corresponding packets.

The local transmission source address is information relating to the address of a device that transmits the management packet 1. Every time the management packet 1 is transmitted to another device in the process of multi-hop communication, this local transmission source address is rewritten as the address of a device (node) serving as the main part of transmission. The global transmission source address is information relating to the address of a device (node) that generates the payload data. In other words, the global transmission source address is information relating to the address of a device serving as a starting point in the multi-hop communication.

The packet type is information indicating the type of the corresponding packet. For example, in a case of being the time packet, “0” is set as the packet type, and in a case of being the hello packet, “1” is set as the packet type. In addition, in a case of being the data packet, “2” is set as the packet type.

In accordance with the packet type, each node determines whether or not to transfer the received management packet to another node. For example, in a case of receiving the management packet where “0” is set as the packet type, the node Nx transfers the received management packet to another node Nx. In other words, the time packet is transferred, as a target of the multi-hop communication, in a network.

On the other hand, in a case of receiving the management packet where “1” is set as the packet type, the node Nx does not transfer the received management packet to another node Nx. In other words, the hello packet is excluded from targets of the multi-hop communication, and the transfer of the hello packet converges in one of nodes.

In addition, in one of the present embodiments, since, as for the management packet, a data configuration is standardized between the hello packet and the time packet, the local transmission source address and the global transmission source address are included in the header information in the hello packet. However, a same address is set as the local transmission source address and the global transmission source address in the hello packet, only the local transmission source address may be set as the header information of the hello packet.

The additional information is header information other than the above-mentioned address and packet type, and is information according to the type of a packet. For example, in a case where a packet is the time packet, the additional information is information relating to a hop count. In addition, the hop count is stored, as the additional information, in the header information storage portion of the packet 1. The hop count is the number of times the packet is subjected to the multi-hop communication. For example, in a case where the node Nc receives, through the node Na and the node Nb, the time packet transmitted by the sink node SN, “3” is set, as the hop count, in the time packet received by the node Nc.

In addition, in a case where the packet is the hello packet, the additional information is the information of a node type. In addition, the node type is stored, as the additional information, in the header information storage portion 2 of the packet 1. The node type is information indicating the type of a node that generates the hello packet, and is an identifier for identifying the type of the node. In a case where the node that generates the hello packet is, for example, the verification node Ntest, the node type is “3”. In addition, for example, in a case where the node that generates the hello packet is not the verification node Ntest, the node type is “4”.

The payload data is information other than the header information. In addition, the content of the payload data varies depending on the type of a packet. In a case where the packet is, for example, the time packet, the information of time is stored, as the payload data, in the payload data storage portion 3 of the packet 1. Each node Nx or the verification node Ntest, which has received the time packet, acquires the information of time from the payload data storage portion 3, and sets time in the device itself in accordance with the information thereof.

In addition, in a case where the packet is, for example, the hello packet, information including a session key is stored, as the payload data, in the payload storage unit 3 of the packet 1. The session key is a key used for performing communication between two nodes out of the individual nodes Nx and the verification node Ntest. The session key is used in a case of encrypting the payload data, or the like.

Each node encrypts the payload data using a session key according to a transmission destination. Therefore, a node to transfer the data packet decrypts the payload data within a received data packet, using a session key of the node itself, and after that, re-encrypts the payload data, using a session key corresponding to a subsequent transmission destination. By decrypting the payload data, it is possible for the node to verify the validity of a transmission source in the received data packet.

Each node Nx or the verification node Ntest, which has received the hello packet, acquires the information of a session key from the payload data storage portion 3, and stores the session key in the key information storage unit of each node Nx or the verification node Ntest while associating the session key with the local transmission source address.

On the other hand, the payload data may be encrypted using not the session key but a server key shared with the sink node SN or the server S. In a case where the server key is used for encrypting the payload data, each node does not have to decrypt and re-encrypt the payload data within the received packet. In a case where the sink node SN is specified as the global transmission destination address, the payload data is decrypted when the sink node SN receives the packet.

In this way, in a case where the server key is used for encrypting the payload data, each node Nx does not have to perform processing for decryption and re-encryption. Therefore, compared with a case of encrypting the payload data using the session key, a processing load is reduced. In addition, in a case where the server key is used for encryption, the payload data storage portion 3 of the hello packet may be empty. In one of the present embodiments, it is assumed that the server key is used for encryption, and description will be performed.

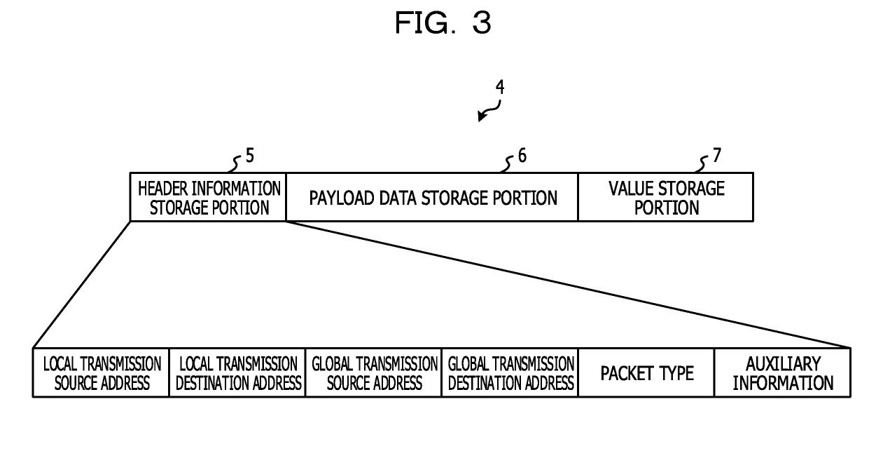

FIG. 3 illustrates an example of the data configuration of the data packet. A data packet 4 includes a header information storage portion 5, a payload data storage portion 6, and a value storage portion 7. Header information is stored in the header information storage portion 5. The header information includes a local transmission source address, a local transmission destination address, a global transmission source address, a global transmission destination address, a packet type, and auxiliary information. Payload data is stored in the payload data storage portion 6. A value calculated with predetermined data within the packet as a target is stored in the value storage portion 7.

The local transmission source address, the global transmission source address, and the packet type in the data packet 4 are the same pieces of information as those in the management packet 1. In this regard, however, in a case of the data packet 4, “2” is set as the packet type.

The local transmission destination address is information relating to the address of a device to serve as the transmission destination of the data packet 4, in one piece of communication that forms the multi-hop communication. The global transmission destination address is information relating to the address of a device to finally receive the payload data described in the payload data storage portion 6. In other words, the global transmission destination address is information relating to the address of a device to serve as an ending point in the multi-hop communication.

The auxiliary information is header information other than various kinds of address and the packet type. As the auxiliary information, information relating to, for example, a hop count, the date and time of transmission, and so forth is stored in the header information storage portion 5.

The payload data is information other than the header information and the value. The payload data is, for example, data acquired by each node Nx from a sensor. The data of a power consumption amount acquired by, for example, the node Nc is set in the payload data storage portion 6.

The value is a value indicating a predetermined logical relationship with predetermined data within the data packet 4. This value is, for example, a MAC value calculated with the payload data, the global transmission destination address, and the global transmission source address as targets.

The data packet 4 illustrated in FIG. 3 flows within the ad hoc network in accordance with routing tables included in the individual nodes Nx and the verification node Ntest. In one of the present embodiments, the completeness of data is verified for the payload data within the data packet 4, and the validity of the global transmission source is verified.

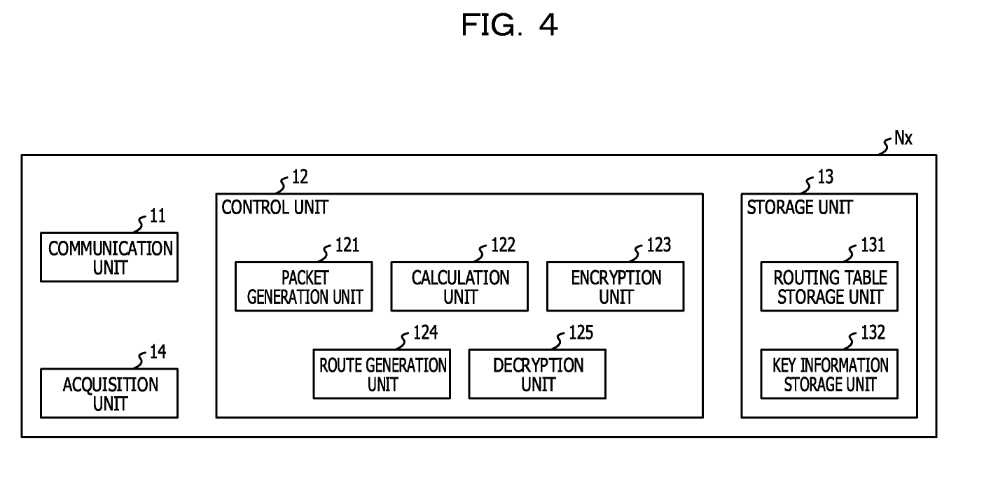

Next, using FIG. 4, processing units in the node Nx will be described. FIG. 4 is the functional block diagram of the node Nx.

The node Nx includes a communication unit 11, a control unit 12, a storage unit 13, and an acquisition unit 14. The communication unit 11 is a processing unit that performs wireless communication with another node Nx, the verification node Ntest, or the sink node SN. The communication unit 11 transmits and receives hello packets and data packets to and from, for example, another node Nx existing in a communication area. In a case of being capable of performing communication with the verification node Ntest, the communication unit 11 transmits a data packet to the verification node Ntest.

The control unit 12 is a processing unit that controls various kinds of processing in the node Nx. In a case where the node Nx is, for example, a global transmission source, the control unit 12 generates various kinds of packet. In addition, based on the management packet, the control unit 12 generates a routing table. In addition, based on the routing table, the control unit 12 determines a node to serve as the local transmission destination of a data packet.

The storage unit 13 stores therein various kinds of information. The storage unit 13 stores therein, for example, an encryption key used for encryption processing, a routing table, and so forth. The storage unit 13 includes a routing table storage unit 131 and a key information storage unit 132.

The acquisition unit 14 is a processing unit that acquires data. The acquisition unit 14 acquires a piece of data such as a power consumption amount or temperature from, for example, a sensor being able to communicate with the node Nx. In addition, the acquired data is transmitted, as the payload data of a data packet, to another node Nx, the verification node Ntest, or the sink node SN.

In addition, the control unit 12 includes a packet generation unit 121, a calculation unit 122, an encryption unit 123, a route generation unit 124, and a decryption unit 125.

The packet generation unit 121 is a processing unit that generates the data packet and the hello packet. In a case where the node Nx is, for example, a global transmission source, the packet generation unit 121 sets the address of the node itself in the global transmission source address and the local transmission source address in the header information storage portion 5. Furthermore, the packet generation unit 121 determines a global transmission destination address, and sets the determined global transmission destination address in the header information storage portion 5.

In addition, the packet generation unit 121 sets, in the payload data storage portion 6, data acquired by the acquisition unit 14. In addition, with reference to the routing table stored in the storage unit 13, the packet generation unit 121 determines the local transmission destination address of the data packet. The packet generation unit 121 sets the determined address in the local transmission destination address in the header information storage portion 5. Furthermore, the packet generation unit 121 sets, in the header information storage portion 5, the packet type, “2”, indicating the data packet.

In a case of transferring a received data packet, the packet generation unit 121 performs processing for updating the data packet. The local transmission source address and the local transmission destination address are updated by this processing. Details of this processing will be described later.

On the other hand, in a case of generating the hello packet, the packet generation unit 121 sets the address of the node itself in the global transmission source address and the local transmission source address in the header information storage portion 2. The packet generation unit 121 sets “1” in the packet type of the hello packet, and sets, as the node type, “4” in the additional information of the hello packet. The node type, “4”, indicates not being the verification node Ntest. In addition, the packet generation unit 121 sets, in the payload data storage portion 3, predetermined information such as the information of the session key.

The calculation unit 122 is a processing unit that calculates a value having a predetermined logical relationship with predetermined data within the data packet in a case where the node Nx is to be a global transmission source. In one of the present embodiments, the calculation unit 122 calculates a MAC value for the payload data, the global transmission destination address, and the global transmission source address, using, for example, a MAC key. The MAC key is preliminarily shared by the node Nx, the verification node Ntest, and the sink node SN. In addition, the MAC key may be a key different with respect to each node Nx.

The encryption unit 123 executes encryption processing for the payload data as appropriate. The encryption unit 123 encrypts the payload data using, for example, an encryption key stored in the key information storage unit 132.

Based on a management packet received by the communication unit 11, the route generation unit 124 generates a routing table. In addition, the route generation unit 124 stores the generated routing table in the routing table storage unit 131. In addition, the route generation unit 124 updates the routing table every time the management packet is received, or periodically.

Next, the decryption unit 125 decrypts the encrypted payload data as appropriate. With reference to, for example, the header information storage portion within the packet, the decryption unit 125 determines whether a global transmission destination address is the address of the node itself. In a case where the global transmission destination address is the address of the node itself, the decryption unit 125 decrypts the payload data.

In addition, the control unit 12 in the node Nx may further include a verification unit. In addition, in a case where a processing load is less than or equal to a predetermined load with respect to the processing capacity of the node Nx, the control unit 12 may cause the verification unit to function. Using a value stored in the received packet, the verification unit verifies the completeness of the payload data and the validity of the global transmission source. This verification unit only has to perform the same processing as that of an after-mentioned verification unit 223 in the verification node Ntest.

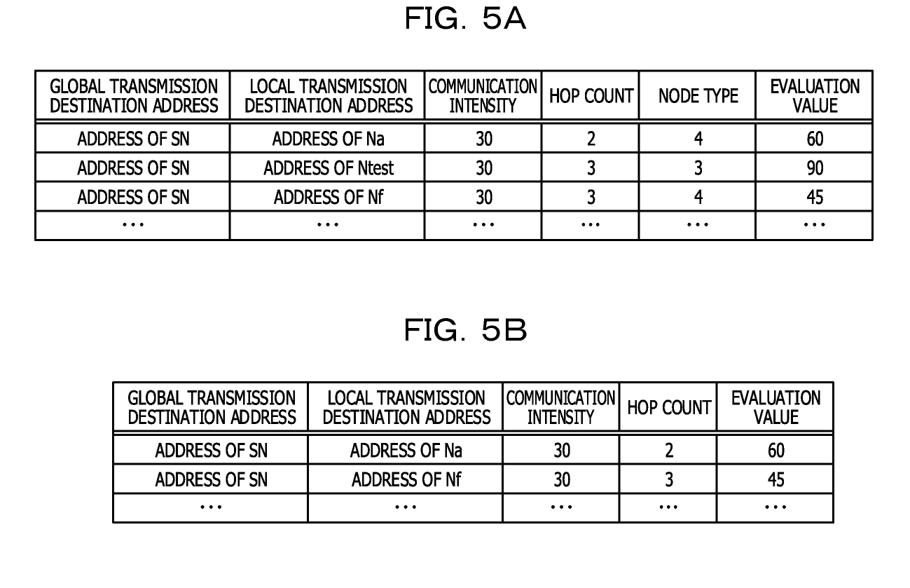

FIG. 5A and FIG. 5B are diagrams for comparing an example of the data configuration of a routing table of the related art with an example of the data configuration of a routing table according to one of the present embodiments. FIG. 5A illustrates an example of the data configuration of a routing table according to one of the present embodiments. FIG. 5B illustrates an example of the data configuration of a routing table of the related art.

A routing table stored in the routing table storage unit 131 in one of the present embodiments stores therein a global transmission destination address, a local transmission destination address, a communication intensity, a hop count, a node type, and an evaluation value while associating the global transmission destination address, the local transmission destination address, the communication intensity, the hop count, the node type, and the evaluation value with one another. In addition, FIG. 5A illustrates a routing table included in the node Nb.

On the other hand, the routing table of the related art stores therein a global transmission destination address, a local transmission destination address, a communication intensity, a hop count, and an evaluation value while associating the global transmission destination address, the local transmission destination address, the communication intensity, the hop count, and the evaluation value with one another. In other words, the routing table of the related art does not include information relating to a node type.

In addition, while, in order to describe a difference with the routing table of the related art, an example where the routing table illustrated in FIG. 5A includes the communication intensity, the hop count, and the node type is illustrated, the communication intensity, the hop count, and the node type may be managed in another table other than the routing table. In this case, an evaluation value calculated based on the communication intensity, the hop count, and the node type is stored while being associated with the global transmission destination address and the local transmission destination address. Furthermore, only the combination of the global transmission destination address where an evaluation value is greater than or equal to a predetermined value and the local transmission destination address may be stored in the routing table.

The global transmission destination address is the information of the address of a device corresponding to an ending point in the multi-hop communication. The local transmission destination address is the information of the address of a device to serve as the transmission destination of communication performed between adjacent nodes within the multi-hop communication. The information of the address of another adjacent node with which the node Nx is able to communicate directly is stored as the local transmission destination address.

The communication intensity is a value indicating the strength of stability in communication between the node itself and a node corresponding to each local transmission destination address. The communication intensity is calculated based on, for example, a signal reception intensity, or the number of management packets and the number of data packets, the management packets and the data packets being received from a node corresponding to the local transmission destination address. In addition, the communication intensity may be calculated based on a communication success probability, an error rate, a receiving electric field intensity, or the like. In the present embodiment, the communication intensity is the sum of the number of management packets and the number of data packets, the management packets and the data packets being received from a node corresponding to the local transmission destination address.

The hop count is a value indicating how many times a management packet transmitted by a node corresponding to a global transmission destination address is transferred by other nodes until the node itself receives the management packet. For example, the hop count set as the additional information within the time packet is stored in an item, “hop count”, in the routing table.

The node type is information indicating the type of node corresponding to the local transmission source address. Information corresponding to the node type set in the hello packet is stored in an item, “node type”, in the routing table.

The evaluation value is a value indicating which address it is desirable to set the local transmission destination of a data packet to, with respect to each combination of a global transmission destination address and a local transmission destination address. In other words, the evaluation value indicates the magnitude of a possibility that the data packet is transmitted to each local transmission destination address. The evaluation value is calculated based on the communication intensity, the hop count, and the node type.

The evaluation value is calculated as a value that increases with an increase in the communication intensity and a decrease in the hop count. Furthermore, the evaluation value is calculated so as to be a large value in a case where the node type indicates that a node corresponding to the local transmission destination address is a verification node. Based on, for example, Expression 1, the evaluation value is calculated.

X=(A/B)×α×β (1)

In addition, in Expression 1, the evaluation value, the communication intensity, the hop count, a given value, and an evaluation coefficient are expressed as X, A, B, α, and β, respectively. In addition, the given value is a value for correcting the evaluation value so that the evaluation value falls within an adequate range. For example, the α is “6”. In addition, the evaluation coefficient is a value for performing weighting according to the node type. In other words, the value thereof is changed in accordance with the node type. In a case where the node type is, for example, “3” indicating being a verification node, the β is “2”. On the other hand, in a case where the node type is “4” indicating not being a verification node, the β is “1”.

Here, as illustrated in FIG. 5B, the routing table of the related art does not manage the node type. Accordingly, in the ad hoc network of the related art, the evaluation value is calculated without adding the node type. Therefore, in a case of following a method of the related art, the evaluation value increases with an increase in the communication intensity and furthermore a decrease in the hop count. For example, an evaluation value illustrated in FIG. 5B is calculated. Therefore, in a case where the global transmission destination address is set to the address of the sink node SN, the node Nb determines, as the local transmission destination, the node Na where the evaluation value is the highest.

On the other hand, according to one of the present embodiments, the verification node Ntest is provided within the ad hoc network, and furthermore, the node type is added in the calculation of the evaluation value. The evaluation value corresponding to the verification node Ntest is weighted compared with the evaluation value of another node Nx. For example, in a case where the node type is “3” indicating the verification node Ntest, the route generation unit 124 in the node Nx adopts “2” as the evaluation coefficient. Therefore, compared with a case of being the node Nx, it is possible to double an evaluation value relating to the verification node Ntest.

Accordingly, in one of the present embodiments, in a case where the global transmission destination address is set to the address of the sink node SN, the node Nb determines, as the local transmission destination, the verification node Ntest where the evaluation value is the highest. Therefore, a data packet desired to be subjected to verification is transferred to the verification node Ntest.

In addition, in the node Nx other than the node Nb, in a case of being able to communicate with the verification node Ntest, an evaluation value for defining the verification node Ntest as the local transmission destination is weighted, and hence, a possibility that the data packet is transferred to the verification node Ntest increases. Eventually, in the entire ad hoc network system, a possibility that a packet is transferred through the verification node Ntest increases, and an improper packet is effectively discarded from the ad hoc network.

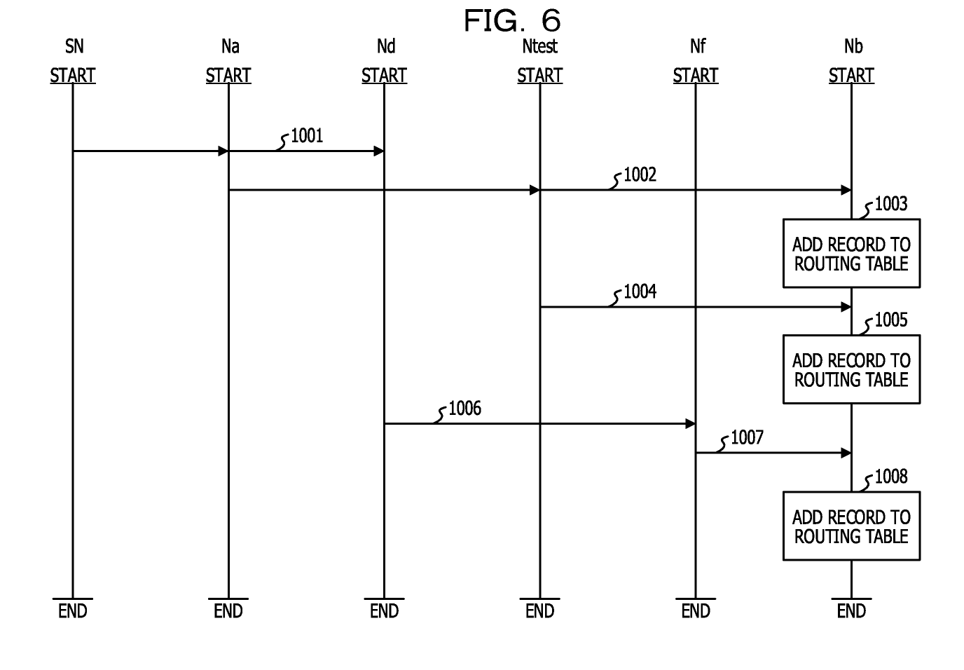

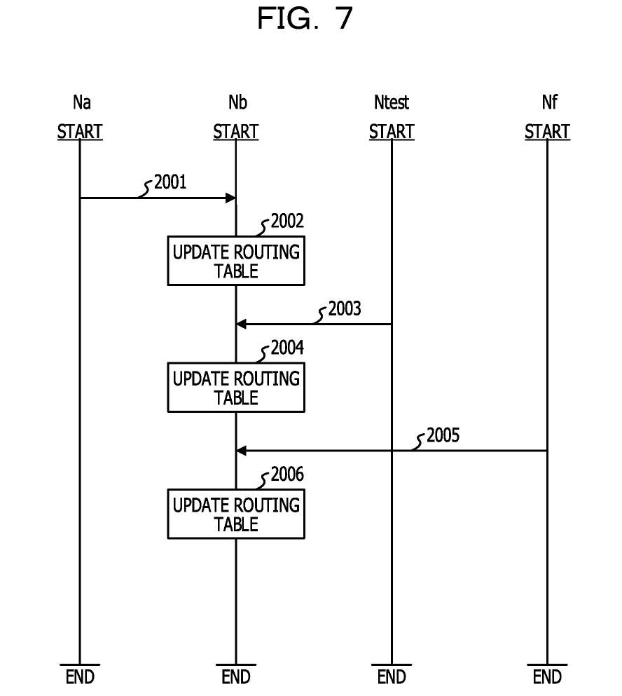

Next, using FIG. 6 and FIG. 7, generation of a routing table based on transmission and reception of a management packet will be described in detail. First, the generation of the routing table in a case where the node Nx receives the time packet will be described. FIG. 6 is a diagram for explaining a path through which a time packet is transferred from the sink node SN to the node Nb. In addition, the route generation unit 124 in the node Nx generates the routing table.

A plurality of paths through which the time packet passes while being transmitted from the sink node SN and received by the node Nb may be considered. In addition, FIG. 6 illustrates three paths out of the plural paths. In order to explain some paths, FIG. 6 illustrates the node Na, the node Nb, the node Nd, the node Nf, the verification node Ntest, and the sink node SN out of the nodes Nx illustrated in FIG. 1.

In addition, in paths not illustrated in FIG. 6, the time packet flows within the ad hoc network, using the multi-hop communication. Furthermore, nodes other than the node Nb each generate the routing table in response to the reception of the time packet.

It is assumed that the nodes Nx being able to communicate with the sink node SN are the node Na and the node Nd in FIG. 6. In addition, it is assumed that the node Na is able to communicate with the verification node Ntest and the node Nb. It is assumed that the node Nb is able to communicate with the node Na, the node Nc, the node Nf, and the verification node Ntest. It is assumed that the node Nd is able to communicate with the sink node SN, the node Ne, and the node Nf. It is assumed that the node Nf is able to communicate with the node Nb, the node Nd, the node Ng, the node Nh, and the verification node Ntest. It is assumed that the verification node Ntest is able to communicate with the node Na, the node Nb, and the node Nf.

First, the sink node SN sets a particular address used for broadcasting, as a destination address within the time packet. Furthermore, the sink node SN sets the address of the sink node SN, as the local transmission source address and the global transmission source address within the time packet. Furthermore, the sink node SN sets, as the packet type within the time packet, “0” indicating being the time packet. In addition, the sink node SN sets the hop counts, “1”, as the additional information within the time packet. In addition, the sink node SN stores information relating to time, in the payload data storage portion 3 within the time packet. In addition, the sink node SN broadcasts the time packet created in such a way.

In a case where, for example, a power supply is turned on, the sink node SN broadcasts the time packet (processing operation 1001). In addition, if, as described above, it is assumed that the nodes being able to communicate with the sink node SN are the node Na and the node Nd, the time packet broadcasted in the processing operation 1001 is received by the nodes Na and Nd. Since an address set as the destination address of the received packet is a particular address, each of the node Na and the node Nd recognizes the received packet as a packet addressed to the node itself.

Here, among the plural paths, there is a path (referred to as a path 1 hereinafter) where the time packet arrives at the node Nb from the sink node SN through node Na. In the path 1, the time packet transmitted by the sink node SN is received by the node Na being able to communicate with the sink node SN (processing operation 1001). Since the packet type of the received packet is “0”, the node Na further transfers the received packet.

In addition, before the transferring, the node Na updates the local transmission source address, and the hop count serving as the additional information, within the time packet. Specifically, the node Na sets the address of the node Na as the local transmission source address, and adds “1” to the hop count. Therefore, the additional information is updated to the hop count, “2”. While, here, generation of the routing table in the node Na is not described in detail, the node Na performs generation processing for the routing table in a case of receiving the time packet.

In addition, the node Na broadcasts the updated time packet (processing operation 1002). The time packet broadcasted by the node Na is received by the node Nb being able to communicate with the node Na. In addition, in the example in FIG. 6, the broadcasted time packet is also received by the verification node Ntest being able to communicate with the node Na.

Pieces of information such as “the address of the sink node SN”, “the address of the node Na”, and the hop count, “2”, are set as the global transmission source address, the local transmission source address, and the additional information, respectively, in the time packet that arrives at the node Nb through the path 1.

Next, the node Nb newly adds a record to the routing table (processing operation 1003). Specifically, the node Nb sets the global transmission source address, “the address of the sink node SN”, within the time packet, as the global transmission destination address in the routing table. In addition, the node Nb sets the local transmission source address, “the address of the node Na”, within the time packet, as the local transmission destination address in the routing table. In addition, the node Nb sets the hop count, “2”, serving as the additional information within the time packet, as the hop count in the routing table. In addition, the node Nb further transfers the received time packet in the same way as other nodes.

In this ad hoc network, in addition to the path 1, there is a path (referred to as a path 2 hereinafter) where the time packet arrives at the node Nb from the sink node SN through the node Na and the verification node Ntest. In the path 2, the time packet individually broadcasted in the processing operations 1001, 1002, and 1004 in FIG. 6 is received by the node Nb.

Pieces of information such as “the address of the sink node SN”, “the address of the verification node Ntest”, and the hop count, “3”, are set as the global transmission source address, the local transmission source address, and the additional information, respectively, in the time packet that arrives at the node Nb through the path 2.

The node Nb that receives the time packet transferred through the path 2 newly adds a record to the routing table (processing operation 1005). Specifically, the node Nb sets the global transmission source address, “the address of the sink node SN”, within the time packet, as the global transmission destination address in the routing table. In addition, the node Nb sets the local transmission source address, “the address of the node Ntest”, within the time packet, as the local transmission destination address in the routing table. In addition, the node Nb sets the hop count, “3”, serving as the additional information within the time packet, as the hop count in the routing table.

In addition, in this ad hoc network, in addition to the path 1 and the path 2, there is a path (referred to as a path 3 hereinafter) where the time packet arrives at the node Nb from the sink node SN through the nodes Nd and Nf. In the path 3, the time packet individually broadcasted in the processing operations 1001, 1006, and 1007 in FIG. 6 is received by the node Nb.

Pieces of information such as “the address of the sink node SN”, “the address of the node Nf”, and the hop count, “3”, are set as the global transmission source address, the local transmission source address, and the additional information, respectively, in the time packet that arrives at the node Nb through the path 3.

The node Nb that receives the time packet transferred through the path 3 newly adds a record to the routing table (processing operation 1008). Specifically, the node Nb sets the global transmission source address, “the address of the sink node SN”, within the time packet, as the global transmission destination address in the routing table. In addition, the node Nb sets the local transmission source address, “the address of the node Nf”, within the time packet, as the local transmission destination address in the routing table. In addition, the node Nb sets the hop count, “3”, serving as the additional information within the time packet, as the hop count in the routing table.

In addition, while not illustrated in FIG. 6, there is also the time packet that arrives at the node Nb from the sink node SN through the node Na, the verification node Ntest, and the node Nf. In this case, “the address of the sink node SN”, “the address of the node Nf”, and the hop count, “4”, serving as the additional information within the time packet are set as the global transmission destination address, the local transmission destination address, and the hop count, respectively, in the routing table. However, in a case where a record in which the combination of the global transmission address and the local transmission destination address is the same has already existed in the routing table, only a record where the hop count is smaller may be adopted, and another record may be discarded.

In the following description, in a case where a record in which the combination of the global transmission address and the local transmission destination address is the same exists in the routing table, only a record where the hop count is smaller is registered in the routing table.

In addition, when the global transmission destination address, the local transmission destination address, and the hop count are added to the routing table, initial values may be set as the communication intensity and the node type that correspond to the corresponding record. In that case, for example, “10” and “4” may be set as the communication intensity and the node type, respectively.

Next, using FIG. 7, update of the routing table in a case where the node Nx receives a hello packet will be described. FIG. 7 is a diagram for explaining transmission and reception of a hello packet between nodes. In addition, the route generation unit 124 in the node Nx updates the routing table.

The packet generation unit 121 in each node Nx generates a hello packet. For example, the node Na sets, as a destination address within the hello packet, an address for broadcasting. Furthermore, the node Na sets the address of the node Na as the global transmission source address and the local transmission source address within the hello packet. Furthermore, the node Na sets, as the packet type within the hello packet, “1” indicating being the hello packet. In addition, the node Na sets, as the additional information within the hello packet, “4” indicating not being the verification node.

The node Na broadcasts the generated hello packet (processing operation 2001). The node Nb being able to communicate with the node Na receives the hello packet from the node Na. In addition, while not illustrated in FIG. 7, another node being able to communicate with the node Na receives the hello packet from the node Na. The node Nb updates the routing table, based on the received hello packet (processing operation 2002). In addition, since the packet type of the received packet is “1”, the node Nb causes the transfer of the received hello packet to converge.

In the update processing for the routing table, the node Nb acquires the local transmission source address, “the address of the node Na”, within the received hello packet. In addition, with reference to the routing table stored in the storage unit 13, a record where “the address of the node Na” is stored as the local transmission destination address is identified.

In addition, the node Nb updates the communication intensity in the identified record. In a case where the number of packets received from the node Na is utilized as, for example, the communication intensity, the node Nb adds a predetermined number to the communication intensity in the routing table every time the hello packet is received. For example, “5” is added every time the hello packet or the data packet is received. In addition, the node Nb may calculate the number of reception packets per unit time, or the like, and may store the calculated number of reception packets in the communication intensity.

In addition, if the node type in the routing table and the node type set as the additional information within the hello packet do not match each other, the node Nb updates the node type in the routing table. As the node type within the hello packet received from the node Na, the node type, “4”, indicating that the node Na is not the verification node is set. On the other hand, as described above, as for the node type in the routing table, “4” is set as an initial value at the time of creating a record. Therefore, since the node type within the received hello packet matches the node type in the routing table, the node type in the routing table is not updated.

Based on the communication intensity, the hop count, and the node type, the node Nb calculates the evaluation value every time various kinds of packet are each received, or periodically. In addition, the node Nb re-registers the calculated new evaluation value in the routing table.

In addition, as illustrated in FIG. 7, in a case where the hello packet is broadcasted from the verification node Ntest (processing operation 2003), the node type in the routing table is updated, and in a case where the hello packet is broadcasted from the node Nf (processing operation 2005), the node type in the routing table is updated in the same way (processing operations 2004 and 2006). The node type, “3”, is set in the hello packet received from the verification node Ntest, and the node type in the hello packet and the node type in the routing table do not match each other. Therefore, the node type in the routing table is updated to the node type, “3”. Accordingly, the node type is also updated in the processing (processing operation 2004) for updating the routing table, and the evaluation value is also updated in accordance with the updated node type.

In addition, FIG. 7 is an example of the sequence of receiving the hello packets from the node Na and the verification node Ntest. In the same way as the node Na, the node Nb broadcasts the hello packet.

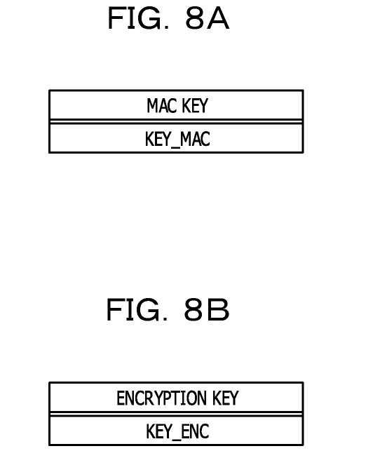

FIG. 8A and FIG. 8B are examples of data stored in the key information storage unit 132. The key information storage unit 132 stores therein the information of a MAC key illustrated in FIG. 8A. In addition, the key information storage unit 132 stores therein the information of an encryption key illustrated in FIG. 8B. In addition, in one of the present embodiments, a MAC key and an encryption key, shared by all the nodes, are used.

In addition, one of the MAC key and the encryption key or both thereof may be different for each node. For example, the node Nx corresponding to the global transmission source address may calculate the MAC value using a MAC key different for each node. In addition, the calculated MAC value may be set in the value storage portion of the data packet.

In a case of receiving a data packet, the verification node Ntest performs verification using a MAC key corresponding to the global transmission source address within the data packet.

Furthermore, the node Nx corresponding to the global transmission source address may encrypt information to be stored in the payload data storage portion, using an encryption key different for each node Nx. In this case, a device to serve as a global transmission destination understands an encryption key for each node Nx in advance. In a case of receiving, for example, a data packet where the sink node SN is set as the global transmission destination address, the sink node SN decrypts data (payload data) using an encryption key corresponding to the node Nx of the global transmission source address.

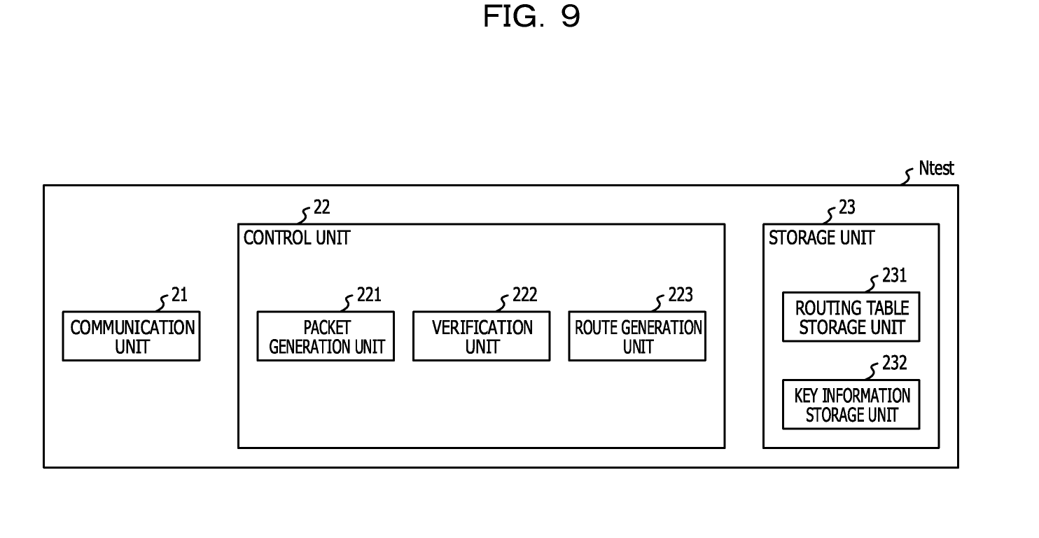

Next, using FIG. 9, processing units in the verification node Ntest will be described. FIG. 9 is the functional block diagram of the verification node Ntest.

The verification node Ntest includes a communication unit 21, a control unit 22, and a storage unit 23. In addition, in the same way as the node Nx, the verification node Ntest may include an acquisition unit that acquires a detection value detected by a sensor.

The communication unit 21 is a processing unit that performs wireless communication with the node Nx. The communication unit 21 transmits and receives hello packets and data packets to and from, for example, other nodes Nx. In addition, the communication unit 21 receives a data packet from a node Nx, and transfers the data packet to another node Nx.

The control unit 22 is a processing unit that controls various kinds of processing in the verification node Ntest. The control unit 22 verifies, for example, data packets. In addition, the control unit 22 generates a hello packet in which the node type, “3”, is set.

The storage unit 23 stores therein various kinds of information. The storage unit 23 stores therein, for example, an encryption key used for encryption processing, a routing table, and so forth. The storage unit 23 includes a routing table storage unit 231 and a key information storage unit 232. In addition, the respective data configurations of the routing table storage unit 231 and the key information storage unit 232 are the same as those of the node Nx.

The control unit 22 includes a packet generation unit 221, a verification unit 222, and a route generation unit 223. The control unit 22 in the verification node Ntest may further include an encryption unit and a decryption unit in the same way as the node Nx.

The packet generation unit 221 is a processing unit that generates the hello packet and updates the data packet. The packet generation unit 221 generates, for example, a hello packet where “1” is set as the packet type and “3” is set as the node type in the additional information of the hello packet.

The verification unit 222 is a processing unit that verifies packets. In addition, the verification unit 222 calculates a value having a predetermined logical relationship with a received packet. In addition, by comparing the calculated value with a value stored in the value storage portion 7 of the received packet, the verification unit 222 verifies the completeness of the received packet and the validity of a node that generates the packet. In one of the present embodiments, the verification unit 222 utilizes, for example, the MAC value as the value.

The route generation unit 223 generates a routing table, based on the management packet. In addition, the route generation unit 223 stores the generated routing table in the routing table storage unit 231. In addition, the route generation unit 223 updates the routing table every time the management packet is received, or periodically.

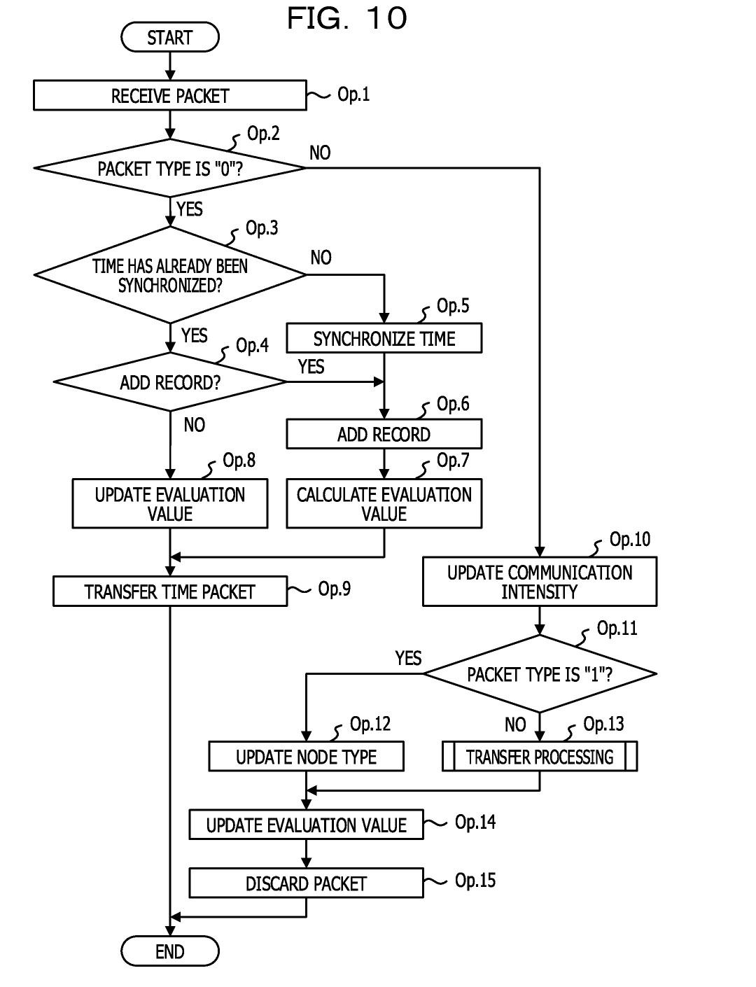

Here, routing table generation processing by the node Nx and the verification node Ntest according to one of the present embodiments will be described. FIG. 10 is a flowchart of the routing table generation processing.

While, hereinafter, the routing table generation processing in a case where the node Nx is a main part will be described, the same processing is performed in the verification node Ntest. In this regard, however, in a case where the main part is the verification node Ntest, the communication unit 11, the route generation unit 124, and the routing table storage unit 131 are replaced with the communication unit 21, the route generation unit 223, and the routing table storage unit 231, respectively.

The communication unit 11 receives a packet (Op. 1). In addition, the route generation unit 124 determines whether the packet type set within the received packet is “0” (Op. 2). In a case where the packet type is “0” (Op. 2: YES), the received packet is the time packet.

The control unit 12 determines whether time set in a timing unit in the node Nx has already been synchronized with the time packet. In addition, the timing unit is a processing unit included in the node Nx in addition to the individual processing units illustrated in FIG. 4. In a case where the time set in the timing unit has not yet been synchronized with the time packet (Op. 3: NO), the control unit 12 synchronizes the time in the timing unit with the time packet (Op. 4).

On the other hand, in a case where the time in the timing unit has already been synchronized with the time packet (Op.3: YES), the route generation unit 124 references the header information storage portion within the received packet. In addition, the route generation unit 124 determines whether or not a record exists in the routing table, the record including the combination of the global transmission destination address and the local transmission destination address in the routing table, which matches the combination of the global transmission source address and the local transmission source address stored in the header information storage portion (Op. 4). In other words, in the Op. 4, the route generation unit 124 determines whether or not it is desirable to newly add a record to the routing table.

In a case where it is desirable to newly add a record to the routing table (Op. 4: YES), the route generation unit 124 newly adds a record to the routing table (Op. 6). Specifically, the route generation unit 124 acquires the global transmission source address from the received packet, and sets the acquired global transmission source address as the global transmission destination address in the routing table. In addition, the route generation unit 124 acquires the local transmission source address from the received packet, and sets the acquired local transmission source address as the local transmission destination address in the routing table. The route generation unit 124 acquires the additional information from the received packet, and sets the acquired additional information as the hop count in the routing table.

In addition, at the time of the Op. 6, the route generation unit 124 sets, for example, “4”, as the initial value of the node type in the routing table. In addition, the route generation unit 124 sets, for example, “10”, as the initial value of the communication intensity.

In addition, based on the communication intensity, the hop count, and the node type, the route generation unit 124 calculates the evaluation value (Op. 7). The calculated evaluation value is stored in the record added in the Op. 6.

On the other hand, in a case where it is not desirable to newly add a record to the routing table (Op. 4: NO), the route generation unit 124 identifies a record including the local transmission destination address in the routing table, which matches the local transmission source address set in the received packet. In addition, the route generation unit 124 updates the communication intensity in the identified record. The route generation unit 124 adds, for example, “5” to the communication intensity.

In addition, the route generation unit 124 updates the evaluation value, based on the updated communication intensity (Op. 8). In addition, in a case where there are a plurality of records each including the local transmission destination address in the routing table, which matches the local transmission source address set in the received packet, the evaluation values of the respective records are updated.

For example, in the flow in FIG. 10, the route generation unit 124 adds a predetermined number to the communication intensity every time a new packet is received. In the Op. 8, only the communication intensity may be updated. In addition, the route generation unit 124 may periodically calculate the evaluation value.

Next, the communication unit 11 transfers the received time packet (Op. 9). Specifically, after the local transmission source address and the hop count within the time packet are updated by the route generation unit 124, the communication unit 11 broadcasts the time packet. In addition, while a series of processing operations is terminated, in a case of newly receiving a packet, the node Nx executes this series of processing operations for the packet.

In a case where the packet type is not “0” (Op. 2: NO), the route generation unit 124 identifies a record including the local transmission destination address in the routing table, which matches the local transmission source address set within the packet. In addition, the route generation unit 124 updates the communication intensity in the identified record (Op. 10).

Next, the route generation unit 124 determines whether the packet type set in the received packet is “1” (Op. 11). If the packet type is “1” (Op. 11: YES), the received packet is the hello packet. In a case where the packet type is “1”, the node type in the routing table is updated based on information acquired from the additional information (Op. 12).

Information relating to the node type is set as the additional information in the hello packet. Accordingly, in a case where a node that transmits the hello packet is the verification node Ntest, the node type in the routing table is updated from the initial value, “4”, to “3”.

On the other hand, in a case where the packet type is not “1” (Op. 11: NO), the received packet is the data packet. Therefore, the after-mentioned transfer processing is executed (Op. 13).

Next, the route generation unit 124 calculates the evaluation value, based on the communication intensity, the hop count, and the node type in the routing table (Op. 14). In addition, the evaluation value may be calculated at intervals of a given period of time. In addition, the control unit 12 discards the hello packet or the data packet (Op. 15).

Based on the above-mentioned processing, each node Nx generates and updates the routing table. In addition, by receiving a packet including the node type, each node Nx understands whether or not the verification node Ntest is included in nodes being able to communicate with the node itself. In addition, so as to transfer the data packet to the verification node Ntest on a priority basis, each node Nx weights the evaluation value for the verification node Ntest in the routing table.

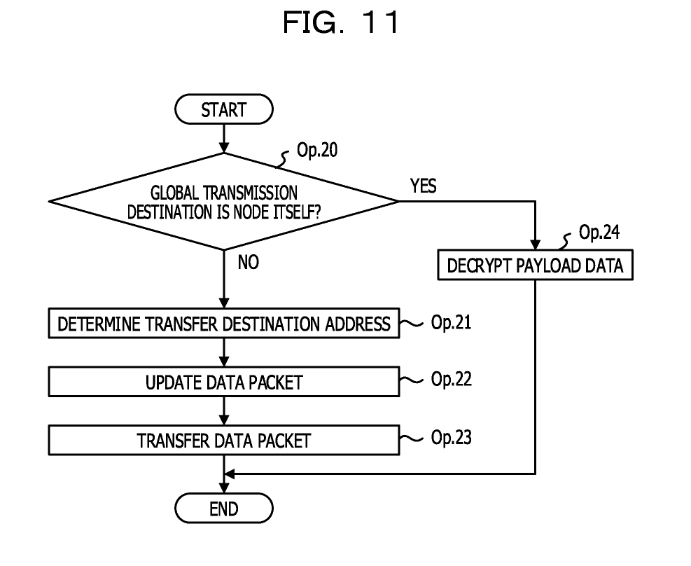

Next, transfer processing in the node Nx according to one of the present embodiments will be described. FIG. 11 is the flowchart of the transfer processing in the node Nx.

The control unit 12 determines whether or not the global transmission destination address within the data packet matches the address of the node itself (Op. 20). In a case where the global transmission destination address within the data packet matches the address of the node itself, it is understood that a node specified as the global transmission destination of the received data packet is the node itself.

In a case where the global transmission destination is the node itself (Op. 20: YES), the decryption unit 125 decrypts payload data within the data packet (Op. 24). In addition, an encryption key stored in the key information storage unit 132 is used for decryption processing.

On the other hand, in a case where the global transmission destination is not the node itself (Op. 20: NO), the transfer destination address is determined with reference to the routing table (Op. 21). Specifically, from among records in the routing table, which include the same global transmission destination address as the global transmission destination address set in the data packet, the packet generation unit 121 identifies a record including the highest evaluation value. In addition, the packet generation unit 121 determines, as the transfer destination address of the data packet, the local transmission destination address included in the identified record.

Here, in a case where the local transmission destination address in the record including the highest evaluation value matches the local transmission source address within the received data packet, the packet generation unit 121 identifies a record including the next highest evaluation value, from among records in the routing table, which include the same global transmission destination address as the global transmission destination address set in the data packet. In addition, the packet generation unit 121 determines, as the transfer destination address, the local transmission destination address included in that identified record. The reason is to avoid sending back the received data packet to a node serving as the local transmission source.

Subsequently, the packet generation unit 121 rewrites the local transmission destination address of the received data packet with the determined transfer destination address, and rewrites the local transmission source address with the address of the node itself (Op. 22). In addition, the communication unit 11 transfers the updated data packet to the local transmission destination address (Op. 23).

Based on the above-mentioned processing, the data packet is transferred to the transfer destination address where the evaluation value is the highest in the routing table. In one of the present embodiments, since weighting where the evaluation value relating to the verification node Ntest becomes a high value, compared with other nodes, is performed, a possibility that the data packet is transferred to the verification node Ntest increases. In addition, in addition to it that the evaluation value is weighted and the local transmission destination address is determined based on the evaluation value, the local transmission destination address included in, for example, a record where the node type is “3” in the routing table may be determined as the transfer destination.

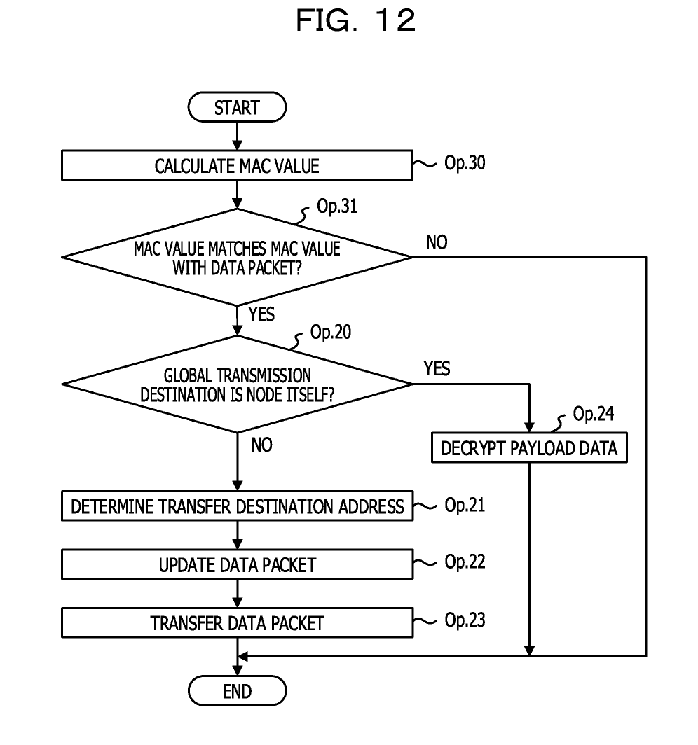

Next, transfer processing in the verification node Ntest will be described. FIG. 12 is the flowchart of the transfer processing in the verification node Ntest. In addition, in a case where the transfer processing in FIG. 10 is the transfer processing in the verification node Ntest illustrated in FIG. 12, it is desirable that the main parts of individual processing operations in FIG. 10 are individual processing units in the verification node Ntest.

The verification unit 222 calculates a MAC value for the payload data, the global transmission source address, and the global transmission destination address within the data packet (Op. 30). A MAC key stored in the key information storage unit 232 is used at the time of calculating the MAC value. In addition, the verification unit 222 compares a MAC value stored in the value storage portion of the data packet with the calculated MAC value (Op. 31).

In a case where the two MAC values match each other (Op. 31: YES), the present processing proceeds to an Op. 20. The Op. 20 to the Op. 24 are the same as those in the transfer processing in the node Nx. In this regard, however, in the transfer processing executed by the verification node Ntest, the communication unit 11, the route generation unit 124, and the routing table storage unit 131 are replaced with the communication unit 21, the route generation unit 223, and the routing table storage unit 231, respectively.

On the other hand, in a case where the two MAC values do not match each other (Op. 31: NO), the verification node Ntest terminates the transfer processing. In other words, the data packet is not transferred. In addition, as illustrated in FIG. 10, after the transfer processing is terminated, the data packet is discarded in the Op. 15.

Based on the above-mentioned processing, as for the data packet received by the verification node Ntest, the completeness of data and the validity of a node that generates the data packet are verified. Based on this verification processing, a data packet in which data is tampered and a data packet generated by an improper node are excluded from targets of transfer.

According to one of the present embodiments, by introducing, into the ad hoc network system, the verification node Ntest whose processing capacity is higher than the nodes Nx, verification processing in the nodes Nx is reduced. In addition, the evaluation value is weighted so that transfer to the verification node Ntest is prioritized, in the routing table generation processing in each node Nx. Accordingly, since a possibility that the data packets are transferred to the verification node Ntest increases, the data packets flowing within the ad hoc network are effectively verified by the verification node Ntest.

Here, in a case of receiving the data packet, the sink node SN in the ad hoc network system transfers the payload data within the data packet, to the server S. The verification processing is performed prior to the transfer processing for the server S, performed by the sink node SN, and hence, transmitting, to the server S, data where the completeness of the data or the validity of a node that generates the data packet is not ensured is avoided.

In a case where an improper node transmits, for example, a large number of packets to the ad hoc network, it is conceivable that a large verification load occurs in the sink node SN in the ad hoc network system of the related art. According to one of the present embodiments, since at least some of a large number of packets are verified and discarded in the verification node Ntest, a load due to the verification processing in the sink node SN is reduced.

As described above, based on the verification by the verification node, the ad hoc network system of one of the present embodiments effectively discards a data packet whose data is incomplete or a data packet generated by a node not sharing the MAC key. Furthermore, a method of the related art for discarding packets due to retransmission attack may be adopted in the ad hoc network system of one of the present embodiments in conjunction with one of the present embodiments.

The retransmission attack is performed as follows. For example, an improper node improperly participates in the ad hoc network, and captures a legitimate data packet flowing through the ad hoc network. In addition, the improper node makes a large number of duplicate copies of the captured packet. In other words, a large number of duplicate copies of a packet where data within data packets is complete and that each further include a MAC value calculated using a legitimately shared MAC key are made. In addition, by throwing a large number of duplicate copies of a data packet into the ad hoc network, the improper node congests the ad hoc network.

As one of methods for discarding packets due to the retransmission attack for the ad hoc network system, there is, for example, a method for updating the MAC key at intervals of a given period of time. Each node Nx and the verification node Ntest each update the MAC key in accordance with a predetermined rule. In addition, by standardizing the predetermined rules between legitimate nodes in advance, the MAC keys individually updated in the respective nodes become the same. Accordingly, since the MAC values within the data packets duplicated by the improper node are different from the updated MAC key, these data packets are discarded based on MAC verification utilizing the updated MAC key.

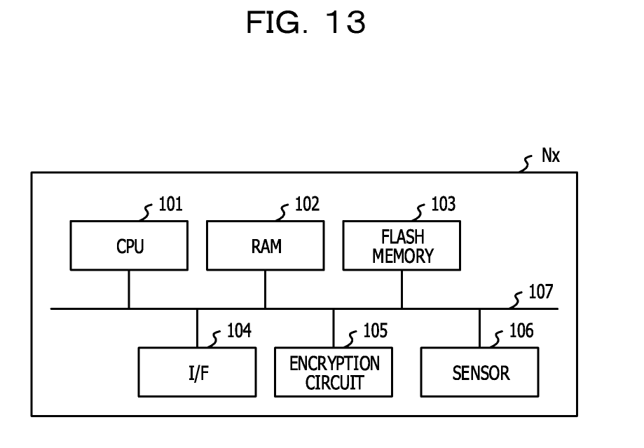

FIG. 13 is an example of the hardware configuration of the node Nx. The node Nx includes a central processing unit (CPU) 101, a random access memory (RAM) 102, a flash memory 103, an interface (I/F) 104, an encryption circuit 105, a sensor 106, and a bus 107. The CPU 101 to the sensor 106 are coupled to one another through the bus 107.

The CPU 101 manages the control of the entire node Nx. By executing a program loaded into the RAM 102, the CPU 101 functions as the control unit 12, the acquisition unit 14, and so forth.

The RAM 102 is used as a work area for the CPU 101. The flash memory 103 stores therein programs, various kinds of key information, and the routing table. In addition, the flash memory 103 is an example of the storage device 13. Examples of the programs include a program used for causing individual processing operations illustrated in the flowcharts to be executed. A control program used for causing the node Nx to execute, for example, the routing table generation processing and the packet transfer processing is stored in the flash memory 103.

The program stored in the flash memory 103 is loaded into the RAM 102 and executed by the CPU 101, and hence, the node Nx functions as various kinds of processing unit described in FIG. 4. In addition, the node Nx executes the processing operations in FIG. 10 and FIG. 11.

The I/F 104 transmits and receives packets using the multi-hop communication. The I/F 104 is an example of the communication unit 11.

The encryption circuit 105 is a circuit that encrypts data using an encryption key in a case of encrypting the data. For example, in a case of encrypting and transmitting packets, the encryption circuit 105 functions. In a case of executing encryption in a software manner, the encryption circuit 105 becomes redundant, by causing the flash memory 103 to store therein a program corresponding to the encryption circuit 105 and causing the CPU 101 to execute the program.

The sensor 106 detects data specific to the sensor 106. For example, the sensor 106 detects data suitable for a measurement target, such as a temperature, humidity, a water level, a precipitation amount, an air volume, a sound volume, an electric power usage amount, the amount of time, time, or acceleration. In addition, when the CPU 101 functions as the acquisition unit 14, the CPU 101 acquires data from the sensor 106.

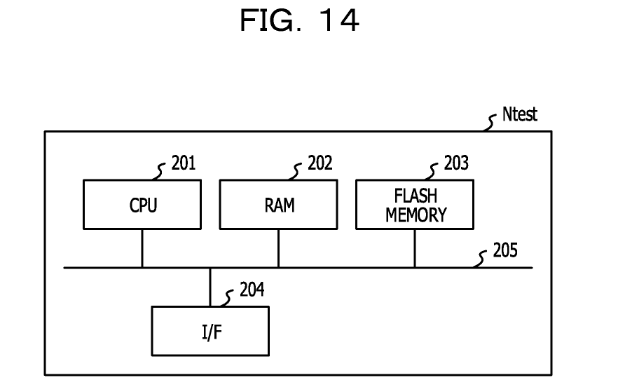

FIG. 14 is an example of the hardware configuration of the verification node Ntest. The verification node Ntest includes a central processing unit (CPU) 201, a random access memory (RAM) 202, a flash memory 203, an interface (I/F) 204, and a bus 205. The CPU 201 to the I/F 204 are coupled to one another by the bus 205. In addition, the verification node Ntest may further include an encryption circuit and a sensor.

The CPU 201 manages the control of the entire verification node Ntest. By executing a program loaded into the RAM 202, the CPU 201 functions as the control unit 22 and so forth.

The RAM 202 is used as a work area for the CPU 201. The flash memory 203 stores therein programs, various kinds of key information, and the routing table. In addition, the flash memory 203 is an example of the storage device 23. Examples of the programs include a program used for causing individual processing operations illustrated in the flowcharts to be executed. A control program used for causing the verification node Ntest to execute, for example, the routing table generation processing and the packet transfer processing is stored in the flash memory 203.

The program stored in the flash memory 203 is loaded into the RAM 102 and executed by the CPU 201, and hence, the verification node Ntest functions as various kinds of processing unit described in FIG. 9. In addition, the verification node Ntest executes the processing operations in FIG. 10 and FIG. 12.

The I/F 204 transmits and receives packets using the multi-hop communication. The I/F 204 is an example of the communication unit 21.

In addition, the verification node Ntest may be a general-purpose computer. In this case, a communication control program describing the routing table generation processing and the packet transfer processing illustrated in the flowcharts is recorded in a computer readable recording medium. Examples of the computer readable recording medium include a magnetic recording device, an optical disk, a magneto-optical recording medium, and a semiconductor memory. Examples of the magnetic recording device include an HDD, a flexible disk (FD), and a magnetic tape (MT).

Examples of the optical disk include a Digital Versatile Disc (DVD), a DVD-RAM, a Compact Disc-Read Only Memory (CD-ROM), and a CD-Recordable (R)/ReWritable (RW). Examples of the magneto-optical recording medium include a magneto-optical disk (MO). In a case of distributing the communication control program, it may be considered that portable recording media such as, for example, DVDs and CD-ROMs, in each of which the program is recorded.

In addition, in a computer to execute the communication control program, for example a recording medium reading device reads the program from a recording medium recording therein the control program. In addition, a CPU in the general-purpose computer stores the read program in the HDD, or the ROM and the RAM.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A network system comprising:
a plurality of node devices including a first node device and a second node device; and
a verification node device that has a higher processing capacity than the plurality of node devices,
wherein
the verification node device transmits a first packet including an identifier indicating the verification node device,
the first node device
receives a second packet from another node device out of the plurality of node devices, and
determines, based on a destination of the second packet, reception of a packet from the second node device, and reception of the first packet, a transmission destination of a third packet that corresponds to reception of the second packet, from among the second node device and the verification node device, and
the verification node device verifies the third packet in a case of receiving the third packet.

2. The network system according to claim 1, wherein
the first node device
calculates, based on the first packet, the second packet, and the identifier, an evaluation value for determining a transmission destination of a packet, for each of the second node device and the verification node device, and
determines the transmission destination of the third packet, based on the evaluation value.

3. The network system according to claim 2, wherein
each of the plurality of node devices
weights, based on the identifier, the evaluation value for the verification node device higher than evaluation values for the plurality of node devices.

4. The network system according to claim 1, wherein
the third packet includes a first value, and the first value is calculated by the other node device and has a specific logical relationship with at least part of data within the second packet, and
the verification node device
calculates a second value that has a specific logical relationship with at least part of data included in the third packet in a case of receiving the third packet, and
compares the first value and the second value with each other.

5. The network system according to claim 4, wherein
the verification node device
transmits the third packet to the determined transmission destination in a case where the first value and the second value match each other, and
discards the third packet in a case where the first value and the second value do not match each other.

6. The network system according to claim 1, wherein
the first node device
includes a routing table that stores therein first address information, second address information, and type information and associates the first address information, the second address information, and the type information with one another,
registers the first address information and the type information in the routing table, based on a local transmission source address included in a received packet and an identifier indicating a type of a device indicated by the local transmission source address, and
determines a transmission destination of the third packet with reference to the routing table.

7. A method of controlling a network system, the method comprising:
transmitting, by a verification node device in the network system, a first packet including an identifier indicating the verification node device, the verification node device having a higher processing capacity than a plurality of node devices in the network system;
receiving, by a first node device among the plurality of node devices, a second packet from another node device out of the plurality of node devices;
determining, by the first node device, based on a destination of the second packet, reception of a packet from the second node device among the plurality of node devices, and reception of the first packet, a transmission destination of a third packet that corresponds to reception of the second packet, from among the second node device and the verification node device; and
verifying, by the verification node device, the third packet in a case of receiving the third packet.

8. The method according to claim 7, further comprising:
calculating, by the first node device, based on the first packet, the second packet, and the identifier, an evaluation value for determining a transmission destination of a packet, for each of the second node device and the verification node device, and
wherein the determining determines the transmission destination of the third packet, based on the evaluation value.

9. The method according to claim 8, further comprising:
weighting, by each of the plurality of node devices, based on the identifier, the evaluation value for the verification node device higher than evaluation values for the plurality of node devices.

10. The method according to claim 7, wherein
the third packet includes a first value, and the first value is calculated by the other node device and has a specific logical relationship with at least part of data within the second packet, and
the method further comprising:
calculating, by the verification node device, a second value that has a specific logical relationship with at least part of data included in the third packet in a case of receiving the third packet; and
comparing, by the verification node device, the first value and the second value with each other.

11. The method according to claim 10, further comprising:
transmitting, by the verification node device, the third packet to the determined transmission destination in a case where the first value and the second value match each other; and
discarding, by the verification node device, the third packet in a case where the first value and the second value do not match each other.

12. The method according to claim 7, wherein the first node device includes a routing table that stores therein first address information, second address information, and type information and associates the first address information, the second address information, and the type information with one another, and
the method further comprising:
registering, by the first node device, the first address information and the type information in the routing table, based on a local transmission source address included in a received packet and an identifier indicating a type of a device indicated by the local transmission source address, and
wherein the determining determines a transmission destination of the third packet with reference to the routing table.

13. A node device in a plurality of node devices included in a network system, the node device comprising:
a memory; and
a processor coupled to the memory and configured to:
transmit a first packet including an identifier indicating a verification node device to the network system,
receive a second packet from another node device among the plurality of node devices, the second packet being a packet addressed to the node device depending on reception of the first packet by the another node device and transmitted from the another node device in response to receiving of a third packet from the network system, and
verify the second packet.

14. The node device according to claim 13, wherein
the second packet includes a first value, and the first value is calculated by the another node device and has a specific logical relationship with at least part of data within the third packet,
the processor is configured to:
calculate a second value that has a specific logical relationship with at least part of data included in the second packet in response to receiving of the second packet, and
compare the first value and the second value with each other.

15. The node device according to claim 14, wherein the processor is configured to:
transmit the second packet to the determined transmission destination in a case where the first value and the second value match each other, and
discard the second packet in a case where the first value and the second value do not match each other.
